(19) United States
(12) Patent Application Publication
(10) Pub. No.: US 2013/0295250 A1
(43) Pub. Date: Nov. 7, 2013

(54) COMPOSITIONS AND METHODS FOR REMOVING SKIN FROM FRUITS OR VEGETABLES

(71) Applicant: Glenn Louis TAYLOR, Herber Springs, AR (US)

(72) Inventor: Glenn Louis TAYLOR, Herber Springs, AR (US)

(21) Appl. No.: 13/887,814

(22) Filed: May 6, 2013

Related U.S. Application Data
(60) Provisional application No. 61/643,276, filed on May 5, 2012.

(51) Int. Cl. A23L 1/00

(52) U.S. Cl. CPC A23L 1/0011
USPC 426/287; 252/500

(57) ABSTRACT

Compositions and methods for removing thin and/or waxy skin of fruits and vegetables, in particular bell peppers, involving the immersion of the fruit or vegetable into a heated mixture that includes an ammonium salt and either hydrogen chloride or carborane, which facilitates the easy removal of the outer coating.

### CROSS REFERENCE TO RELATED APPLICATIONS

This application claims priority to U.S. Provisional Application No. 61/643,276 filed on May 5, 2012, which is incorporated herein by reference.

### FIELD OF THE INVENTION

The present disclosure relates to compositions and methods that are effective in peeling fruit and/or vegetables, in particular bell peppers.

### BACKGROUND OF THE INVENTION

Removing the waxy skin of bell peppers be it green, yellow or red has been done using roasting over an open flame and then kept In a plastic bag to allow steam to be trapped. This process takes 2-5 minutes before the skin can be peeled away from the meaty parts of the pepper. On a commercial basis, this process takes a long time and is very labor intensive. Other techniques include the use of lye treatment, which is sodium hydroxide, a strong corrosive high pH product. This must be followed to be neutralized by the addition of an acid.

There exists a need for a system, composition, and method for peeling tight skinned fruits and/or vegetables or waxy fruit and/or vegetables, especially bell peppers and tomatoes, that will be environmentally friendly and not harm human tissue.

### SUMMARY OF THE INVENTION

The disclosed compositions and methods provide a system for peeling tight skin and waxy fruits and/or vegetables, such as but not limited to bell peppers, and for removing the outer covering of other food products, such as nuts (e.g., pecans, Brazil nuts, almonds, cashews, and peanuts), fish, and shellfish (e.g., rock shrimp). This invention can also be applied to fruits, such as apples and pears, and vegetables, such as tomatoes and other variety of peppers, such as but not limited to Jalapeno, Poblano/Ancho, Chipotle Pepper Serrano, Cayenne, Peperoncini and Anaheim/NuMex Peppers, Aji Amarillo, Aji Colorado, Aji Andean and Lemon Drop, Habanero, Scotch Bonnet, Datil, Fatalii, Billy Goat, Tabasco Pepper, the Zimbabwe Bird Pepper, Cambodian Angkor Sunrise, Brazilian Malagueta, Peruvian Rocotos, Bolivian Locotos, Mexican Manzanos, and sweet peppers, such as Apple Pepper and Lipstick Pepper. The methods of the invention are highly effective on most products that have a distinct outer covering over moist edible portions. This is true whether the covering is a peel, pod, shuck, skin, scale or shell. A non-limiting list of food products that can be treated according to the methods of the present invention to remove their outer skin can be found in, e.g., U.S. Pat. No. 4,569,850, the entire contents of which are incorporated herein by reference.

In a first aspect, the invention features a method of removing the thin and/or waxy skin from fruits or vegetables, which includes the steps of immersing the fruit or vegetable in a heated aqueous solution that has about 5 to about 30 wt % of a composition containing an ammonium salt (e.g., ammonium chloride or ammonium sulfate) and hydrogen chloride at a ratio of 1.5:1 to 6.25:1 for about 30 seconds (e.g., about 30 to about 180 minutes or more, such as 30, 40, 50, 60, 70, 80, 90, 100, 110, 120, or 180 seconds), which aids in loosening the skin to improve the peeling process; after a predetermined time in the heated solution, removing the fruit or vegetable so that it may cool to room temperature (e.g., a temperature in the range of about 19° C. to about 27° C., such as 25° C.); and removing the loosened peel from the fruit or vegetable to complete the peeling process. In an embodiment, the aqueous solution also includes a carborane (e.g., trifluoromethanesulfonic acid). In another embodiment, the temperature of the heated aqueous solution is at least about 90° C. (e.g., at least about 90 to 95° C., such as about 90° C. or about 93° C.). In an embodiment, the fruit or vegetable is cooled to room temperature prior to the peeling step. In yet another embodiment, the aqueous composition includes an amount of water in the range of about 70 wt % to about 95 wt %. In still other embodiments, the method includes subjecting the fruit or vegetable to agitation and/or pressure to increase the loosening of the thin and/or waxy skin. In other embodiments, the fruit or vegetable are cooled to room temperature either by air or with the use of a cold water bath. Preferably, the cooled fruit or vegetable will have a temperature that is no warmer than room temperature.

In an embodiment, the aqueous solution for use in the method, which includes ammonium chloride and hydrogen chloride (and optionally a carborane, such as trifluoromethanesulfonic acid) may be prepared by the steps of a) forming a mixture of the hydrogen chloride and the ammonium salt and cooling the mixture to room temperature (e.g., a temperature in the range of about 19° C. to about 27° C., such as 25° C.); and b) mechanically modifying the mixture by applying one or more electrical pulsed charges of direct current of about 1 to 20 amps (e.g., about 2-5 amps) and about 4 to 16 volts (e.g., about 6-12 volts), in which each pulsed charge of direct current lasts about 5 to 60 seconds (e.g., about 30 seconds) and the total length of the one or more pulsed charges is about 20 to 70 minutes (e.g., about 30 minutes). In another embodiment, the pulsed charges are given in a pulsing period having a duration of about 30 seconds on and about 30 seconds off. In an embodiment, after the one or more pulsed charges, the mixture has a conductivity of about 250 to 1500 mV and a proton count of about 0.95×10̂25 to 1.5×10̂25. In still other embodiments, during the method of preparing the aqueous solution, and after the one or more pulsed charges, the mixture is allowed to cool (e.g., to room temperature, such as a temperature in the range of about 19° C. to about 27° C., such as 25° C.) before a second round of one or more electrical pulsed charges of direct current is applied to the mixture; the second round is of sufficient duration and magnitude that, after completion, the mixture has a stable, higher level of conductivity value relative to a mixture that is not treated with the second round of pulsed charges. In another embodiment, the mixture is diluted in about 5 wt % to about 40 wt % water to produce the aqueous composition.

In a second aspect, the invention features an aqueous solution that contains about 5 to about 30 wt % of a composition that includes an ammonium salt (e.g., ammonium chloride or ammonium sulfate) and hydrogen chloride at a ratio of 1.5:1 to 6.25:1 and, optionally, a carborane (such as trifluoromethanesulfonic acid). The aqueous solution may be used in a method of removing the thin and/or waxy skin from a food product (e.g., fruit and vegetables, nuts, fish, or shellfish). The aqueous solution may be prepared by the steps of a) forming a mixture of the hydrogen chloride and the ammonium salt (and, optionally, the carborane, such as trifluoromethanesulfonic acid) and cooling the mixture to room temperature (e.g., a temperature in the range of about 19° C. to about 27° C., such as 25° C.); and b) mechanically modifying the mixture by applying one or more electrical pulsed charges (e.g., 2, 3, 4, or 5 pulsed charges) of direct current of about 1 to 20 amps (e.g., about 2-5 amps) and about 4 to 16 volts (e.g., about 6-12 volts), in which each pulsed charge of direct current lasts about 5 to 60 seconds (e.g., about 30 seconds) and the total length of the one or more pulsed charges is about 20 to 70 minutes (e.g., about 30 minutes). In another embodiment, the pulsed charges are given in a pulsing period having a duration of about 30 seconds on and about 30 seconds off. In an embodiment, after the one or more pulsed charges, the mixture has a conductivity of about 250 to 1500 mV and a proton count of about 0.95×10̂25 to about 1.5×10̂25. In still other embodiments, during the method of preparing the aqueous solution, and after the one or more pulsed charges, the mixture is allowed to cool (e.g., to room temperature, such as a temperature in the range of about 19° C. to about 27° C., such as 25° C.) before a second, or subsequent, round(s) of one or more electrical pulsed charges of direct current is applied to the mixture; the second, or subsequent, round(s) is of sufficient duration and magnitude that, after completion, the mixture has a stable, higher level of conductivity value relative to a mixture that is not treated with the second round of pulsed charges. In another embodiment, the aqueous solution exhibits the ability to maintain a proton count in the range of about 0.95×10̂25 to 1.5×10̂25 for at least one month (e.g., 2-12 months, 1-3 years, or more). In another embodiment, the mixture is diluted in about 5 wt % to about 40 wt % water to produce the aqueous composition.

A third aspect of the invention features a method for making an aqueous solution comprising the steps of a) forming a mixture comprising about 5 wt % to about 30 wt % of a composition comprising an ammonium salt and hydrogen chloride at a ratio of about 1.5:1 to about 6.25:1 and, optionally, a carborane (such as trifluoromethanesulfonic acid), and cooling the mixture to about room temperature (e.g., a temperature in the range of about 19° C. to about 27° C., such as 25° C.); and b) mechanically modifying the mixture by applying one or more electrical pulsed charges (e.g., 2, 3, 4, or 5 pulsed charges) of direct current of about 1 to about 20 amps (e.g., about 2-5 amps) and about 4 to 16 volts (e.g., about 6-12 volts), such that each pulsed charge of direct current lasts about 5 to about 60 seconds (e.g., about 30 seconds) and the total length of the one or more pulsed charges is about 20 to 70 minutes (e.g., about 30 minutes). In an embodiment, the pulsed charges are given in a pulsing period having a duration of about 30 seconds on and about 30 seconds off. In another embodiment, the mixture has a conductivity of about 250 to about 1500 mV and a proton count of about 0.95×10̂25 to about 1.5×10̂25 after the one or more pulsed charges. In still other embodiments, during the method of preparing the aqueous solution, and after the one or more pulsed charges, the mixture is allowed to cool (e.g., to room temperature, such as a temperature in the range of about 19° C. to about 27° C., such as 25° C.) before a second, or subsequent, round(s) of one or more electrical pulsed charges of direct current is applied to the mixture; the second, or subsequent, round(s) is of sufficient duration and magnitude that, after completion, the mixture has a stable, higher level of conductivity value relative to a mixture that is not treated with the second round of pulsed charges. In another embodiment, the aqueous solution exhibits the ability to maintain a proton count in the range of about 0.95×10̂25 to 1.5×10̂25 for at least one month (e.g., 2-12 months, 1-3 years, or more). In another embodiment, the mixture is diluted in about 5 wt % to about 40 wt % water to produce the aqueous composition.

A fourth aspect of the invention features the use of the aqueous solution of the second aspect of the invention in several other application, including in applications where acids are used in food processing, general cleaning, strong base neutralizing, ore processing and cleaning, printed circuit boards, removal of calcium and calcium buildup in storage tanks, milk and water lines, industrial acidizing of petroleum wells, stuck drilling pipelines, all applications where hydrochloric acids may be used, pickling desalination facilities, PCB removal and clean-up, soil remediation from over use of urea, and other sorts, by substituting the aqueous solution for one or more an acid-containing solutions known to be used in these applications.

In this specification and in the claims that follow, reference will be made to a number of terms that shall be defined to have the following meanings:

It must be noted that, as used in the specification and the appended claims, the singular forms “a,” “an” and “the” include plural referents unless the context clearly dictates otherwise. Thus, for example, reference to “a carrier” includes mixtures of two or more such carriers, and the like.

“Admixture” or “blend” as generally used herein means a physical combination of two or more different components.

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps. “Exothermic reaction” means the reaction produces heat.

“Optional” or “optionally” means that the subsequently described event or circumstance can or may not occur, and the description includes instances where the event or circumstance occurs and instances where it does not.

The term “about” is used herein to mean a value that is ±10% of the recited value. Ranges may be expressed herein as from “about” one particular value and/or to “about” another particular value.

When such a range is expressed, another aspect includes from the one particular value and/or to the other particular value. Similarly, when values are expressed as approximations by use of the antecedent “about,” it will be understood that the particular value forms another aspect. It will be further understood that the endpoints of each of the ranges are significant both in relation to the other endpoint and independently of the other endpoint.

A weight percent of a component, unless specifically stated to the contrary, is based on the total weight of the formulation or composition in which the component is included.

By “sufficient amount” and “sufficient time” means an amount and time needed to achieve the desired or stated result. The present disclosure addresses solutions to several unmet needs as defined below. Additional advantages will be set forth in part in the description that follows and in part will be apparent from the description or may be learned by practice of the aspects described below. The advantages described below will be realized and attained by means of the elements and combinations described herein, which are particularly pointed out in the appended claims. It is to be understood that both the foregoing general description and the following detailed description are exemplary and explanatory only and are not restrictive.

### BRIEF DESCRIPTION OF THE DRAWINGS

FIG. 1 is a flowchart of a preferred embodiment of the inventive process using multiple combinations of mechanical enhancement.

FIG. 2 is a flowchart of an alternative embodiment of the inventive process using a single mechanical enhancement process.

FIG. 3 is a block diagram of equipment used in performing an embodiment of the inventive process.

FIG. 4 is a block diagram of an alternative set of equipment used in performing an embodiment of the inventive process.

### DETAILED DESCRIPTION OF THE INVENTION

The invention features compositions and methods for removing the thin and/or waxy skin from fruits, vegetables, such as peppers (e.g., bell peppers), nuts, fish, and shellfish. The methods include the use of chemical separation of the skin from the meaty portion of the food product (e.g., fruits, vegetables, such as peppers (e.g., bell peppers), nuts, fish, and shellfish), which may be used alone or combined with mechanical methods (e.g., agitation and/or pressure). The use of chemical methods to remove the thin and/or waxy skin from the food product (e.g., fruits, vegetables, such as peppers (e.g., bell peppers), nuts, fish, and shellfish) includes exposure to an aqueous solution, which is an admixture of an ammonium salt and a carborane, for example, trifluoromethanesulfonic acid (chemical formula CF₃SO₃H), an admixture of an ammonium salt and hydrogen chloride, or an admixture of an ammonium salt, hydrogen chloride, and a carborane. The solution may be prepared in a container, such as a Pyrex glass container. The solution may be prepared at normal room temperature (e.g., about 19° C. to about 27° C.) and pressure with adequate agitation. The reaction is, as with most acids, exothermic.

Examples of formulation selections and proportions of specific components for the inventive admixture may be known to a person of skill in the art and/or easily derived from routine engineering using this disclosure as a guideline. By way of example, Tables I-II show the selection and proportions of specific components suitable for use to improve the removal of thin and/or waxy skin of fruits and vegetables. These compositions are provided as non-limiting examples of effective compositions. The amount of each component is expressed as ratio.

TABLE 1

| Ingredients | 1 | 2 | 3 | 4 | 5 | 6 |
|---|---|---|---|---|---|---|
| Ammonium sulfate | 1.00 | 1.00 | 1.00 | 1.00 | 1.00 | 1.50 |
| Carborane | 1.50 | 3.00 | 4.00 | 4.75 | 5.50 | 6.25 |

TABLE 2

| Ingredients | 1 | 2 | 3 | 4 | 5 | 6 |
|---|---|---|---|---|---|---|
| Ammonium Chloride | 1.00 | 1.00 | 1.00 | 1.00 | 1.00 | 1.50 |
| Hydrogen Chloride | 1.50 | 3.00 | 4.00 | 4.75 | 5.50 | 6.25 |

The methods and compositions of the invention are described in the following Examples, which further illustrate certain embodiments of the present invention and are not to be considered limiting of the invention.

### EXAMPLE 1

### Preparation of an Admixture for Use in the Methods of the Invention

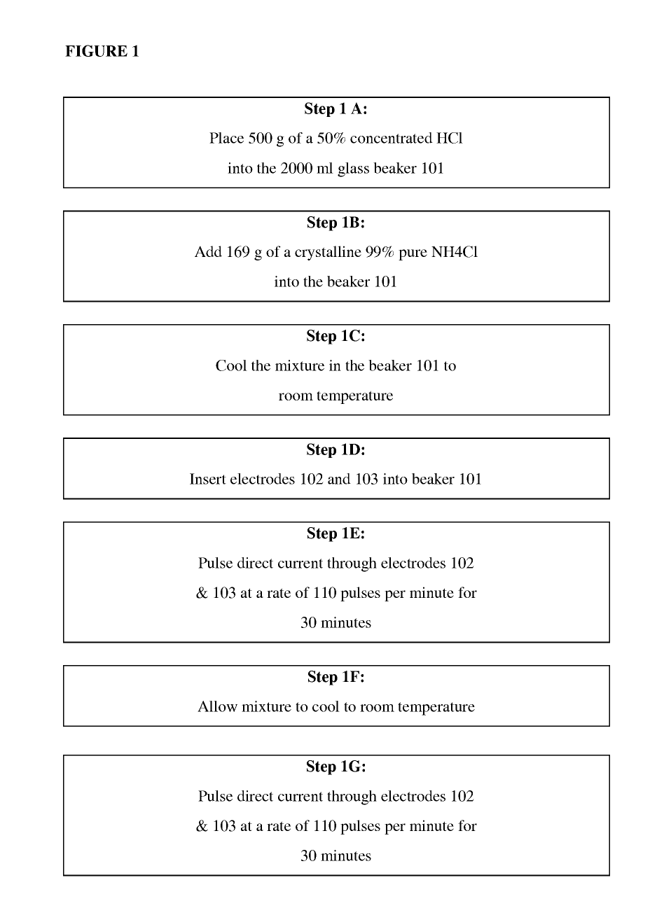

FIG. 1 is a flowchart of a preferred embodiment of the inventive process of preparing a solution for use in the methods for removing the skin from a food product (such as fruits and vegetables) using a strong acid, namely hydrochloric acid, in admixture with an ammonium salt (e.g., ammonium chloride or ammonium sulfate). In step 1A, we placed about 500 grams of a 50% concentrated hydrochloric acid into a 2000 ml glass beaker 101. Other hydrochloric acid stock solutions may also be used (e.g., 30%-50% concentrated hydrochloric acid) to produce the admixture. In step 1B, we added about 169 grams of crystalline 99% pure ammonium chloride to the acid. Addition of the ammonium chloride generated heat, and so we carefully monitored the rate at which we added the ammonium chloride and stirred the mixture regularly. In step 1C, once all of the ammonium chloride was dissolved in the acid, we allowed the admixture to cool to around 25° C. At this point, the admixture contained hydronium and ammonium cations, and hydroxide and chlorine anions; the measured conductivity of the admixture was less than 100 mV, the measured proton count was about 1.0×10̂23 per μb.

Based on our observations, we believe that at this stage of the process, the attractions between the oppositely charged ions in the admixture made it less corrosive to human skin.

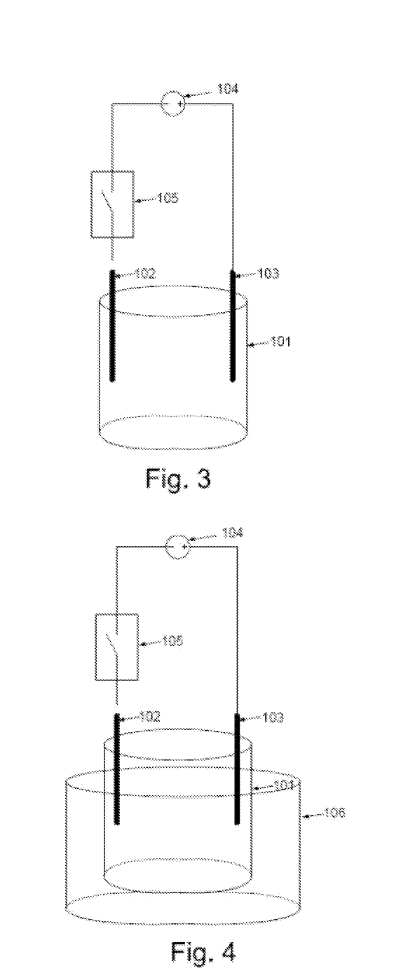

In step 1D, we placed two electrodes 102 and 103 into the beaker 101 at opposite sides of the beaker, away from the walls of the beaker. We connected the electrodes 102 and 103 to a direct current power source 104 with an inline switch 105 allowing the current to turn on and off. Switch 105 could be a manual switch, but in practice we found that we could use a strobe light controller, laboratory voltage pulser, or comparable circuit to provide the direct current pulses. FIG. 3 is a block diagram of the equipment used in an embodiment of the inventive process.

In step 1E, we pulsed the electrodes using a 2-5 amp direct current at 6-12 volts for about 30 minutes, where the pulsing period was about 30 seconds on and 30 seconds off. After allowing the admixture to cool in Step 1F, we found the measured conductivity was about 495 mV and the measured proton count was about 0.95×10̂25 per μb.

In Step 1G, after the first period of pulsing the current through the admixture and after the admixture had cooled, we performed a second round of pulsing, comparable to the first and lasting a length of about 30 minutes. After this second round of pulsing, the measured conductivity was about 1120 mV; the measured proton count was about 0.95×10̂25 per μb. Over time (several months) the conductivity did not measurably decrease, suggesting that the second round of pulsing not only increased the reactivity but added stability to the composition.

Based on our empirical observations, we believe that the controlled application of direct current increases the lengths of the bonds in the polar molecules, leading to higher reactivity. Because the current is pulsed, it does not interfere with the intermolecular bonds between the oppositely-charged ions, thus retaining the composition's non-corrosive and dermal friendly qualities. Thus, this embodiment addresses the need for a composition that is reactive, like a strong acid, yet does not corrode metal or irritate skin.

In other embodiments, the concentration of the acid may be varied without affecting the general process or the characteristics of the resulting composition; however, use of too weak of a concentration may lower the ranges of conductivity and proton count in the final composition and therefore reduce its usefulness. The efficacy of a given concentration of acid can be determined from routine experimentation based on the embodiments disclosed in this patent application.

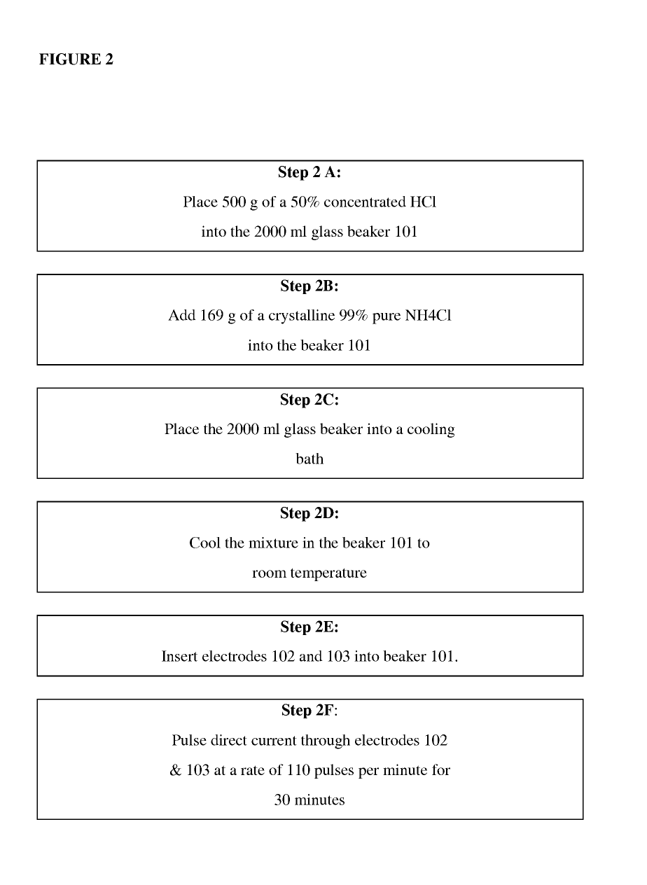

In the embodiment described above, pulsing of the admixture occurred in two steps. In other embodiments, the pulsing can occur in a single step, provided that the temperature of the admixture is kept under about 90° C. using cooling techniques that are known in the art, for example, partially submersing the mixing vessel in a cooling bath, as shown in the block diagram of FIG. 4. The process described in the flowchart of FIG. 2 differs from the process of FIG. 1 in that, after the HCl and NH₄C1 are mixed together, the beaker 101 is placed into a cooling bath 106, which cools the admixture in preparation for charging and maintains the temperature during charging.

In other embodiments, the voltage, amperage, period, and duration of the pulsing current could be varied without adversely affecting the desired properties. Such variations could be necessitated, for example, by the size of the electrodes, the size of the beaker, and the volume of the acid/salt solution. In practice, we found that we could obtain the desired properties of the modified acid/salt solution with voltages ranging from 4 to 16 volts, currents ranging from 1 to 20 amps; pulse periods ranging from 5 to 60 seconds on and 5 to 60 seconds off, and pulsing current duration ranging from 20 to 70 minutes.

After mechanical modification (e.g., pulsing) is completed, the admixture may be stored for future use or diluted with water in an amount ranging from 5 wt % to 40 wt % to produce an aqueous solution for use in the methods of removing the skin from a food product (e.g., fruits or vegetables) discussed below.

While not binding ourselves to specific theories, based on our empirical observations, we believe that the controlled application of the direct current increases the length of the bonds in the molecule, leading to higher reactivity. Further, when the current is pulsed, it does not interfere with the intermolecular bonds, thus retaining and enhancing the composition's non-corrosive and human tissue friendly qualities. Further, because of the stability of the intermolecular bonds, when the mixture is stored under non-adverse conditions (for example away from heat, light, pressure or electromagnetic radiation), it retains its reactive, non-corrosive and human tissue friendly qualities indefinitely (e.g., over several months (e.g., at least 1-2 months) or several years (e.g., 1-3 years) or more). Further, consistent with our observations, we found that when we used a steady (non-pulsed) or alternating current, or higher-power current, or when we failed to control the temperature during the pulsing process, the composition did not have these enhanced reactive, non-corrosive and human tissue friendly qualities. This does not however, preclude the use of other energy sources, such as sound, electricity, light or mechanical sources, provided the application of energy does not break down the intermolecular bonding. Thus, this embodiment addresses the need for a stable composition for use in removing the skin off of a food product, such as a fruit or a vegetable, that is reactive and does not corrode metal or irritate human tissue.

In the preferred embodiment, we used quantities of the various components commensurate with what was practical in a laboratory setting; obviously, in an industrial production setting, the quantities of the various components used would be a function of the manufacturing equipment and desired amount of final product. Designing the optimal manufacturing environment can be derived from the embodiments disclosed in this patent using routine chemical engineering techniques.

This admixture can also be used in several other application, including in applications where acids are used in food processing, general cleaning, strong base neutralizing, ore processing and cleaning, printed circuit boards, removal of calcium and calcium buildup in storage tanks, milk and water lines, industrial acidizing of petroleum wells, stuck drilling pipelines, all applications where hydrochloric acids may be used, pickling desalination facilities, PCB removal and clean-up, soil remediation from over use of urea, and other sorts.

### EXAMPLE 2

### Removing the Skin from Food Products

The aqueous solution produced according to the methods described in Example 1 may be used to remove the skin from a food product, such as fruits, vegetables (e.g., peppers (e.g., bell peppers), nuts, fish, and shellfish). The aqueous solution is heated to about 90° C. and above (e.g., about 80° C. to about 150° C.). The food product is then submerged into the heated aqueous solution for a period of time, which loosens the waxy skin of the food products (e.g., fruits and vegetables, such as bell peppers). To decrease the time the food product (e.g., fruit or vegetable) is submerged in the heated mixture, some agitation can be employed. The expected time of the submersion will vary from about 30 to 120 seconds depending on the size of the food product and whether other mechanical methods (e.g., agitation or pressure) are employed. The food product is then removed from the aqueous mixture and allowed to cool (e.g., to room temperature). Once cooled, the skin can be separated from the meaty portion of the food product. If necessary, the food product may repeatedly immersed in the heated aqueous solution and cooled (e.g., the process may be repeated 1 or more times) until the skin is easily removed from the food product. While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

### Other Embodiments

All publications, patents, and patent applications mentioned in the above specification are hereby incorporated by reference, including U.S. Provisional Application No. 61/643,276 filed on May 5, 2012. Various modifications and variations of the described method and system of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention.

Other embodiments are in the claims.

1. A method for removing thin and/or waxy skin from a fruit or vegetable comprising:
i) immersing the fruit or vegetable in a heated aqueous solution comprising about 5 wt % to about 30 wt % of a composition comprising an ammonium salt and hydrogen chloride at a ratio of about 1.5:1 to about 6.25:1 for about 30 seconds;
ii) removing the fruit or vegetable from the aqueous solution and allowing the fruit or vegetable to cool; and
iii) removing the loosened peel from the fruit or vegetable.

2. The method of claim 1, wherein the temperature of the heated aqueous solution is at least about 90° C.

3. The method of claim 1, wherein the fruit or vegetable is immersed in the heated aqueous solution for a time in the range of about 30 to about 120 seconds.

4. The method of claim 1, wherein the fruit or vegetable is cooled to room temperature prior to step iii).

5. The method of claim 1, wherein the ammonium salt is ammonium sulfate or ammonium chloride.

6. The method of claim 1, wherein said aqueous composition comprises an amount of water in the range of about 70 wt % to about 95 wt %.

7. The method of claim 1, wherein, prior to step i), said aqueous solution is prepared by the steps of:
a) forming a mixture of the hydrogen chloride and the ammonium salt and cooling the mixture to room temperature; and
b) mechanically modifying the mixture by applying one or more electrical pulsed charges of direct current of about 1 to about 20 amps and about 4 to about 16 volts, wherein each pulsed charge of direct current lasts about 5 to about 60 seconds and the total length of the one or more pulsed charges is about 20 to about 70 minutes.

8. The method of claim 7, wherein the ammonium salt is ammonium chloride.

9. The method of claim 7, wherein after the one or more pulsed charges, the mixture has a conductivity of about 250 to about 1500 mV and a proton count of about 0.95'10̂25 to about 1.5×10̂25.

10. The method of claim 7 further comprising:
c) after the one or more pulsed charges, allowing the mixture to cool; and
d) applying a second round of one or more electrical pulsed charges of direct current through the mixture, wherein the second round is of sufficient duration and magnitude that, after completion, the mixture has a stable, higher level of conductivity value relative to a mixture that is not treated with the second round according to step d).

11. The method of claim 1 further comprising subjecting said fruit or vegetable to agitation and/or pressure to increase the loosening of the thin and/or waxy skin.

12. The method of claim 4, wherein the fruit or vegetable is cooled to room temperature either by air or with the use of a cold water bath so that the cooled fruit or vegetable has a temperature that is no warmer than room temperature.

13. The method of claim 1, wherein said aqueous solution further comprises a carborane.

14. The method of claim 13, wherein said aqueous solution is prepared by the steps of:
a) forming a heated mixture of the hydrogen chloride, ammonium salt, and carborane and cooling the mixture to room temperature;
b) mechanically modifying the mixture by applying one or more electrical pulsed charges of direct current of about 1 to 20 amps and about 4 to 16 volts, wherein each pulsed charge of direct current lasts about 5 to about 60 seconds and the total length of the one or more pulsed charges is about 20 to about 70 minutes.

15. The method of claim 14, wherein the ammonium salt is ammonium chloride.

16. The method of claim 14, wherein after the one or more pulsed charges, the mixture has a conductivity of about 250 to 1500 mV and a proton count of about 0.95×10̂25 to about 1.5×10̂25.

17. The method of claim 14 further comprising:
c) after the one or more pulsed charges, allowing the mixture to cool; and
d) applying a second round of one or more electrical pulsed charges of direct current through the mixture, wherein the second round is of sufficient duration and magnitude that, after completion, the mixture has a stable, higher level of conductivity value relative to a mixture that is not treated with the second round according to step d).

18. The method of claim 14 further comprising subjecting said fruit or vegetable to agitation and/or pressure to increase the loosening of the thin and/or waxy skin.

19. The method of claim 14, wherein the fruit or vegetable is cooled either by air or with the use of a cold water bath so that the cooled fruit or vegetable has a temperature that is no warmer than room temperature.

20. An aqueous solution comprising about 5 wt % to about 30 wt % of a composition comprising an ammonium salt and hydrogen chloride at a ratio of about 1.5:1 to about 6.25:1, wherein the mixture has a conductivity of about 250 mV to about 1500 mV and a proton count of about 0.95×10̂25 to about 1.5×10̂25.

21. A method for making an aqueous solution comprising the steps of:
a) forming a mixture comprising about 5 wt % to about 30 wt % of a composition comprising an ammonium salt and hydrogen chloride at a ratio of about 1.5:1 to about 6.25:1 and cooling the mixture to about room temperature; and
b) mechanically modifying the mixture by applying one or more electrical pulsed charges of direct current of about 1 to about 20 amps and about 4 to about 16 volts, wherein each pulsed charge of direct current lasts about 5 to about 60 seconds and the total length of the one or more pulsed charges is about 20 to 70 minutes, wherein after the one or more pulsed charges, the mixture has a conductivity of about 250 to about 1500 mV and a proton count of about 0.95×10̂25 to about 1.5×101̂25.
